(19) United States
(12) Patent Application Publication
(10) Pub. No.: US 2024/0091572 A1
(43) Pub. Date: Mar. 21, 2024

(54) INTEGRATED FASTENER COMPONENTS FOR DETACHABLE STRAP COMPONENT CONFIGURATION IN RESPIRATORY PROTECTIVE DEVICE

(71) Applicant: Honeywell International Inc., Charlotte, NC (US)

(72) Inventors: Hang TIAN, Charlotte, NC (US); Xiaojin HAN, Charlotte, NC (US); En Yi CHEN, Charlotte, NC (US)

(21) Appl. No.: 18/466,424

(22) Filed: Sep. 13, 2023

(30) Foreign Application Priority Data
Sep. 21, 2022 (CN) 202211149510.6

(51) Int. Cl. A62B 18/08; A62B 18/06

(52) U.S. Cl. CPC A62B 18/084; A62B 18/06; A62B 7/10

(57) ABSTRACT

Various embodiments are directed to respiratory protective devices and methods of using the same. In various embodiments, a respiratory protective device comprises a mask component configured to engage a face of a user; and a strap component configured for selective attachment to the mask component, the strap component being further configured to be worn by the user such that the mask component selectively attached thereto is positioned against the user's face, wherein the strap component defines a selectively detachable configuration relative to the relative to mask component; wherein the mask component comprises a plurality of integrated fastener components configured for selective engagement with the strap component to secure the strap component relative to the mask component, the plurality of integrated fastener components being integrally configured as part of the mask component such that the mask component defines a strap component interface configured for detachable attachment to the strap component.

### CROSS-REFERENCE TO RELATED APPLICATIONS

This application claims priority pursuant to 35 U.S.C. 119(a) to Chinese Application No. 202211149510.6, filed Sep. 21, 2022, which application is incorporated herein by reference in its entirety.

### FIELD OF THE INVENTION

Various embodiments of the present disclosure relate generally to a face mask assembly and, more particularly, to apparatuses and methods for providing a respiratory protective device comprising a strap component configured for detachable engagement with one or more integrated fastener components defined by the respiratory protective device.

### BACKGROUND

Applicant has identified many technical challenges and difficulties associated with personal protective equipment such as respirators and other breathing-related protective equipment. Through applied effort, ingenuity, and innovation, Applicant has solved problems related to these wearable accessory arm straps by developing solutions embodied in the present disclosure, which are described in detail below.

### BRIEF SUMMARY

Various embodiments are directed to respiratory protective devices and methods of using the same. In various embodiments, a respiratory protective device may comprise a mask component configured to engage a face of a user; and a strap component configured for selective attachment to the mask component, the strap component being further configured to be worn by the user such that at least a portion of the mask component selectively attached thereto is positioned against the face of the user, wherein the strap component defines a selectively detachable configuration relative to the relative to mask component; wherein the mask component comprises a plurality of integrated fastener components configured for selective engagement with at least a portion of the strap component to secure the strap component relative to the mask component, wherein the plurality of integrated fastener components are integrally configured as part of the mask component such that the mask component defines one or more strap component interfaces at which the mask component is configured for detachable attachment to the strap component.

In various embodiments, the plurality of integrated fastener components of the mask component may comprise a plurality of hook fastener elements configured for engagement with a plurality of loop fastener elements defined by the one or more surfaces of the strap component. In various embodiments, the plurality of integrated fastener components may be provided at an outward-facing surface of the mask component. In various embodiments, the plurality of integrated fastener components may be distributed about the outward-facing surface so as to define one or more strap component interfaces positioned along one or more perimeter edge portions of the outward-facing surface at which the mask component is configured for selective attachment to the strap component. In various embodiments, the one or more strap component interfaces may comprise a plurality of strap component interfaces. In certain embodiments, the plurality of strap component interfaces may comprise a first strap component interface defined by a first portion of the plurality of integrated fastener components arranged in a first array along a first lateral end of the mask component and a second strap component interface defined by a second portion of the plurality of integrated fastener components arranged in a second array along a second lateral end of the mask component. Further, in certain embodiments, the plurality of strap component interfaces may further comprise a third strap component interface defined by a third portion of the plurality of integrated fastener components arranged along a bottom end of the mask component.

In various embodiments, the mask component may comprise a face seal component configured for configured for engagement with the face of the user and an outer shell component configured for attachment relative to the face seal component, wherein the plurality of integrated fastener components are defined by the face seal component. In certain embodiments, both the face seal component and the plurality of integrated fastener components defined by the face seal component may be made via an injection mold process such that the face seal component and the plurality of integrated fastener components are defined by a singular material component. In certain embodiments, the plurality of integrated fastener components may be distributed along one or more perimeter edge portions defined by an outer surface of the face seal component. In various embodiments, at least a portion of the strap component may be made from a 3-dimensional (3D) knitted material. In certain embodiments, at least substantially an entirety of the strap component may be made from the 3D knitted material.

In various embodiments, the strap component may define one or more mask component interfaces comprising a 3D knitted material portion defined by the strap component at which the strap component is configured for selective attachment to a corresponding one of the strap component interfaces defined by the mask component. In various embodiments, the 3D knitted material portion may define at least a portion of a strap component surface such that the selective attachment of the mask component to the strap component is defined at least in part by an engagement of the plurality of integrated fastener elements with the strap component surface defined by the 3D knitted material portion. In various embodiments, the 3D knitted material portion may define a plurality of loop fastener elements configured for selective attachment with the plurality of integrated fastener components of the mask component.

In various embodiments, each of the plurality of loop fastener elements may comprise a top loop portion, one or more side loop portion, and a bottom loop portion that collectively define an inner loop portion, the plurality of loop fastener elements defined by the 3D knitted material portion being arranged in a half-looped interlocking configuration. In various embodiments, the 3D knitted material portion may define a mesh configuration defined by an arrangement of the plurality of loop fastener elements in one or more layers. In various embodiments, each of the plurality of integrated fastening components may comprise a base portion and a head portion, the base portion protruding from a surface of the mask component in an at least partially outward direction away from the surface to a distal base end, and the head portion being positioned at the distal base portion. In certain embodiments, the head portion of each of the integrated fastener components may be defined by a respective plurality of curved engagement arms defined by a curvature directed towards the surface of the mask component from which the integrated fastener component protrudes. Further, in certain embodiments, the head portion of each of the integrated fastener components may be defined by a respective outermost surface having an at least substantially rounded configuration.

### BRIEF DESCRIPTION OF THE DRAWINGS

Reference will now be made to the accompanying drawings, which are not necessarily drawn to scale, and wherein:

FIG. 1 illustrates a perspective view of an exemplary respiratory protective device in accordance with various example embodiments described herein;

FIGS. 2A-2C illustrate various views of a mask component of an exemplary respiratory protective device in accordance with some example embodiments described herein;

FIG. 3A illustrates a perspective view of a strap component of an exemplary respiratory protective device in accordance with various example embodiments described herein;

FIG. 3B illustrates a perspective view of an exemplary respiratory protective device having a detachable strap component in an attached configuration relative to a face seal component of a mask component in accordance with various example embodiments described herein;

FIG. 3C illustrates an isolated view of a portion of an exemplary strap component made via a 3D knitting process and defining a plurality loop fastener elements in accordance with various example embodiments described herein;

FIG. 3D illustrates an exemplary loop fastener element of an exemplary strap component in accordance with various example embodiments described herein; and

FIGS. 4A-4B illustrate isolated views of various components of an exemplary respiratory protective device according to various embodiments described herein.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

It should be understood at the outset that although illustrative implementations of one or more aspects are illustrated below, the disclosed assemblies, systems, and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents. While values for dimensions of various elements are disclosed, the drawings may not be to scale.

The words “example,” or “exemplary,” when used herein, are intended to mean “serving as an example, instance, or illustration.” Any implementation described herein as an “example” or “exemplary embodiment” is not necessarily preferred or advantageous over other implementations.

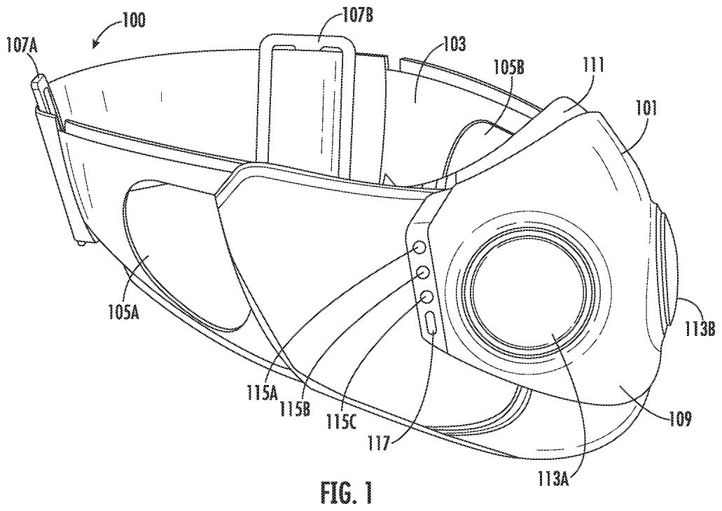

FIG. 1 illustrates a perspective view of an exemplary respiratory protective device in accordance with various example embodiments described herein. In particular, FIG. 1 illustrates an exemplary respiratory protective device 100 comprising a mask component and a strap component, wherein the strap component is configured for selective attachment relative to the mask component via a detachable engagement of the strap component with a plurality of integrated fastener components integrally configured as part of the mask component, in accordance with various embodiments described herein.

In some embodiments, the example respiratory protective device 100 is in the form of a respirator or a mask. For example, as shown in FIG. 1, the example respiratory protective device 100 comprises a mask component 101 and a strap component 103.

In some embodiments, the strap component 103 may be in the form of a mask strap. For example, in some embodiments, the strap component 103 may comprise elastic material(s) such as, but not limited to, polymers, thermoplastic elastomer (TPE), and/or the like. In some embodiments, the elastic material may allow the example respiratory protective device 100 to be secured to a user's face. In various embodiments, an exemplary respiratory protective device 100 may comprise a mask component 101 configured to receive, engage with, and/or otherwise be connected to at least a portion of a strap component 103 configured to be operably coupled with the head (e.g., and/or face) of a user during operation of the respiratory protective device 100 such that the mask component 101 of the respiratory protective device 100 may be worn (e.g., donned) against the face of the user. In various embodiments, the strap assembly 103 may be configured to at least partially encircle the user's head during operation. As described in further detail herein, the strap component 103 of an exemplary respiratory protective device 100 may define one or more mask component interfaces defined by a respective plurality of looped fastener elements configured to define one or more surfaces and/or areas of the strap component 103 (e.g., via one or more 3D knitting processes) at which the strap component 103 is configured to engage a corresponding portion of a mask component 101 (e.g., a corresponding plurality of integrated fastener components defined by the face seal component 111 of the mask component 101) to facilitate the selective attachment of the strap component 103 relative to the mask component 101.

In some embodiments, the strap component 103 may comprise an ear opening 105A and an ear opening 105B. When the example respiratory protective device 100 is worn by a user, the ear opening 105A and the ear opening 105B may allow the user's left ear and the right ear to pass through. In some embodiments, the strap component 103 may be inserted through one or more strap bucket components (such as a strap bucket component 107A and a strap bucket component 107B as shown in FIG. 1). In some embodiments, the one or more strap bucket components may be in the form of one or more buckles that include, but not limited to, a tri-glide buckle), and may allow a user to adjust the length of the strap component 103 so that the example respiratory protective device 100 can be secured to a user's face.

In some embodiments, the mask component 101 may be in the form of a mask or a respirator. For example, as shown in FIG. 1, the mask component 101 may comprise an outer shell component 109 and a face seal component 111.

In some embodiments, when the example respiratory protective device 100 is worn by a user, an outer surface of the outer shell component 109 is exposed to the outside environment. In some embodiments, the face seal component 111 is attached to and extends from a periphery and/or edge of the outer shell component 109 (or an inner shell component of the mask component as described herein).

In some embodiments, the mask component 101 comprises one or more puck components that cover one or more inhalation filtration components of the example respiratory protective device 100. For example, as shown in FIG. 1, the example respiratory protective device 100 comprises a first puck component 113A that is disposed on a left side of the outer shell component 109 and a second puck component 113B that is disposed on a right side of the outer shell component 109. In such an example, the first puck component 113A covers a first inhalation filtration component that is disposed on the left side of the mask component 101, and the second puck component 113B covers a second inhalation filtration component that is disposed on the right side of the mask component 101, details of which are described herein.

In some embodiments, the mask component 101 comprises one or more key components (such as, but not limited to, the key component 115A, the key component 115B, and the key component 115C) that may allow a user to manually control the operations of the fan component of the mask component 101 and/or other devices (such as, but not limited to, earphones) that are in electronic communication with the example respiratory protective device 100.

In various embodiments, the face seal component 111 may comprise soft material such as, but not limited to, silica gel. In some embodiments, when the example respiratory protective device 100 is worn by a user, the face seal component 111 is in contact with the user's face, and may seal the example respiratory protective device 100 to at least a portion of a user's face. For example, in various embodiments, the face seal component 111 may be embody an injection molded component configured for engagement with the face of a user and defining a plurality of integrated fastener components and to facilitate the selective attachment of the strap component a surface of the face seal component 111 (e.g., via the integrated fastener components). As described above, the example respiratory protective device 100 includes strap component 103 that allows the example respiratory protective device 100 to be secured to the user's face. As such, the face seal component 111 can create at least partially enclosed (or entirely enclosed) space between at least a portion of the user's face (e.g. mouth, nostrils, etc.), details of which are described herein.

As illustrated, the mask component 101 may be connected to the strap component 103. In various embodiments, the strap component 103 may be configured for detachable attachment relative to the mask component 101. For example, the strap component 103 may be selectively coupled to the mask component 101 via a non-permanent fastening means to facilitate the selective use and/or replacement of a particular strap component 103 with a mask component 101. In various embodiments, an example respiratory protective device 100 may be configured such that the strap component 103 is configured to be detachably secured to the face seal component 111 of the mask component 101 to facilitate the coupling of the mask component 101 to the strap component 103. As described in further detail herein, the strap component 103 may be selectively coupled to the face seal component 111 at one or more integrated interface portions defined by the one or more locations (e.g., a surface areas) at which the strap component 103 and the face seal component 111 of the mask component 101 are detachably connected to one another.

For example, the mask component 101 may define one or more integrated fastener components configured for selective engagement with at least a portion of the strap component 103 to secure the strap component 103 relative to the mask component 101 (e.g., the face seal component 111 at the integrated fastener components). An exemplary integrated interface portion of a respiratory protective device 100 may be defined by the portion (e.g., surface) of the strap component 103 that is engaged with and/or otherwise operatively attached to the one or more integrated fastener components defined by the mask component 101. In various embodiments, as described herein, the strap component 103 may be formed via a 3-dimensional (3D) knitting process. As used herein, the term “3D knitting” or “3D knitting process” refers to a manufacturing method that may produce a three dimensional product (for example, mask, clothing, garment) as one single piece. For example, the 3D knitting process may be implemented by an 3D knitting machine. The 3D knitting machine may receive one or more digital files that may provide specification(s) of the product (for example, a shape, size, and/or pattern of the strap component 103 of the respiratory protective device 100), and may receive raw material (for example, fiber material). Based on the digital file(s) and the raw material, the 3D knitting machine may produce the strap component 103 of respiratory protective device 100 according to the digital file (e.g., through melt spinning or wet spinning to form the nonwoven material for the strap component 103 of respiratory protective device 100). In various embodiments, at least a portion of the strap component 103 may be made of a 3D knitted material designed such that the surface of the least a portion of the strap component 103 defines a plurality of loop fastener element configured for engagement with the integrated fastener components defined by the mask component 101. For example, the one or more integrated fastener components defined by the face seal component 111 may comprise a hook fastener element configured for selective engagement with the one or more loop fastener elements defined by the 3D knitted material of the strap component 103. In such an exemplary configuration, the integrated interface portion of the respiratory protective device 100 may operatively function as a hook and loop fastening means wherein the face seal component 111 may be selectively attached and/or detached from the strap component 103 via a selective arrangement of the integrated fastener component of the face seal component 111 relative to one or more surface portions of the strap component 103.

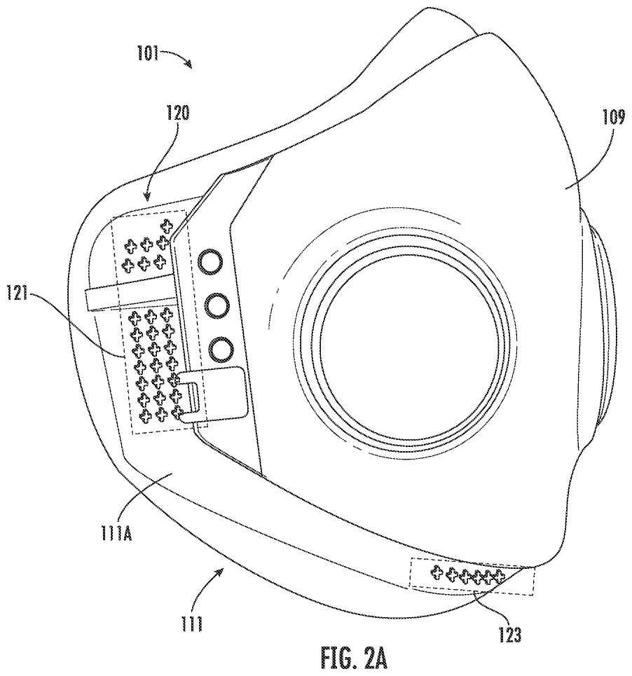

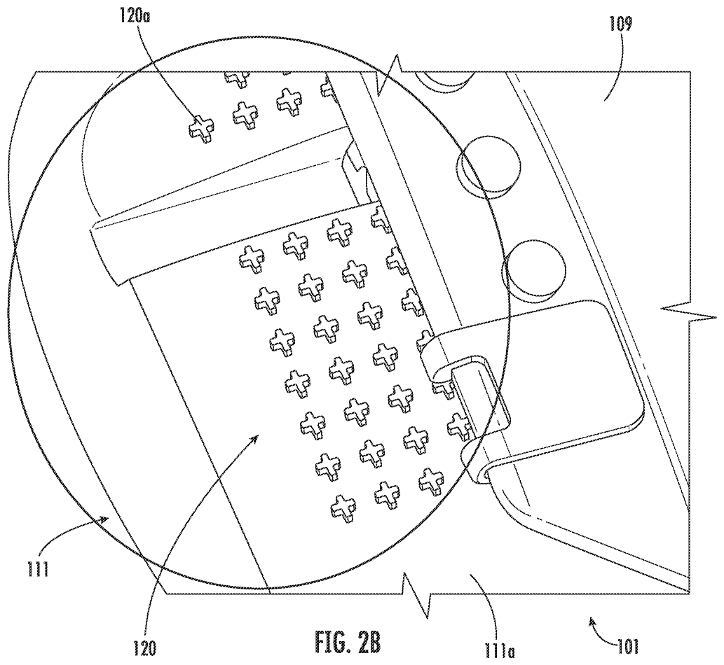

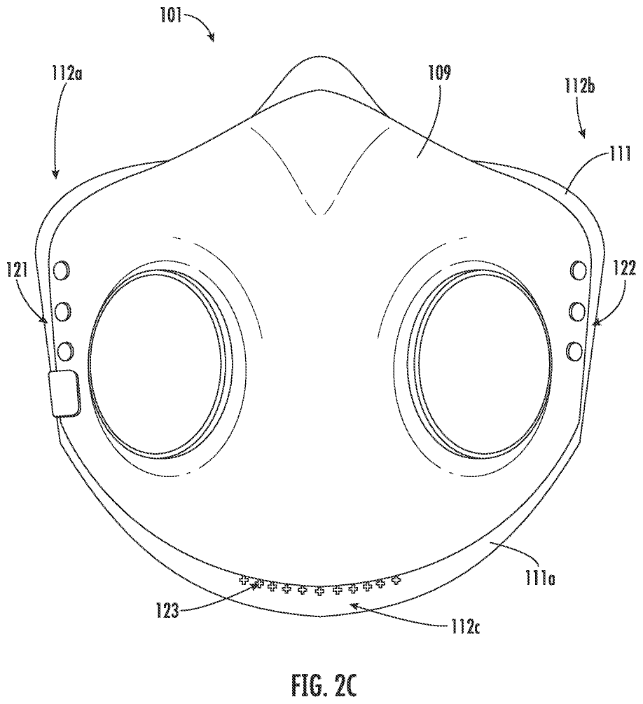

FIGS. 2A-2C illustrate various views of a mask component of an exemplary respiratory protective device in accordance with some example embodiments described herein. In particular, FIG. 2A illustrates an exemplary mask component 101 comprising an outer shell component 109 and a face seal component 111, the face seal component 111 defining a plurality of integrated fastener components configured for detachably securing the mask component relative to a strap component (not shown). As illustrated, the mask component 101 may comprise a plurality of integrated fastener components 120 defined by the face seal component 111. The plurality of integrated fastener components 120 may be disposed along an outer surface 111a of the face seal component 111 (e.g., a surface of the face seal component 111 facing an outward direction away from the face of a user) and configured for attaching to at least a portion of the strap component relative thereto upon an engagement of a surface of the strap component with one or more of the plurality of integrated fastener components 120.

In various embodiments, as illustrated in FIG. 2B, an integrated fastener component 120a of the plurality of integrated fastener components 120 may embody a hook fastener element having an integrated configuration relative to the face seal component 111 such that the face seal component 111 and the plurality of integrated fastener components 120 collectively define a unitary component. A strap component may be selectively secured relative to the mask component at a surface (e.g., an outer surface 111a) of the face seal component 111 at which the plurality of integrated fastener components 120 are disposed. In various embodiments, the face seal component 111 and the plurality of integrated fastener components 120 defined by the face seal component 111 may be made via one or more injection molding processes such that both the face seal component 111 and the plurality of integrated fastener components 120 distributed along the outer surface 111a thereof are defined by a singular material component.

As illustrated, in various embodiments, each of the plurality of integrated fastener components 120 defined by the face seal component 111 may protrude from the outer surface 111a in an at least substantially outward direction away from the face seal component 111. For example, in such an exemplary configuration, The plurality of integrated fastener components 120 may be disposed along an outer surface 111a of the face seal component 111 (e.g., a surface of the face seal component 111 facing an outward direction away from the face of a user.

In various embodiments, the plurality of integrated fastener components 120 may be arranged in one or more grids and/or arrays defining one or more strap component interfaces at which at least a portion of the connection between the mask component 101 and the strap component of an exemplary respiratory protective device 100 may be defined. For example, as illustrated in FIGS. 2A and 2C, a mask component 101 may define one or more strap component interfaces defined by a portion of the plurality of integrated fastener components 120 provided at an edge portion of the outer surface 111a of the face seal component 111, such as, for example, a portion of the outer surface 111a that is at least approximately adjacent a perimeter edge of the face seal component 111. For example, in various embodiments, the one or more strap component interfaces (e.g., a first strap component interface 121 and a third strap component interface 123, shown in FIG. 2A) may be defined along an edge portion of the outer surface 111a such that the strap component interface is exposed, uncovered, and/or otherwise accessible (e.g., for engagement with a strap component) from an exterior position in an exemplary circumstance wherein when the outer shell component 109 is connected to the face seal component 111.

For example, FIG. 2C illustrates an exemplary mask component 101 wherein the plurality of integrated fastener components defined by the face seal component 111 are distributed about the outer surface 111a of the face seal component 111 in an arrangement defined by a plurality of strap component interfaces. For example, the plurality of integrated fastener components may be positioned at various locations along an outer surface 111a of the face seal component 111 such that the mask component 101 may define a first strap component interface 121, a second strap component interface 122, and a third strap component interface 123. In various embodiments, the plurality of strap component interfaces 121, 122, 123 may be defined by the plurality of integrated fastener components of the face seal assembly 111 being arranged in a plurality of distinct grids distributed along respective portions of the outer surface 111a. As described herein, each of the first, second, and third strap component interfaces 121, 122, 123 may be configured for selective engagement with a respective portion of the strap component (not shown) of the respiratory protective device 100 to facilitate a more robust attachment of the strap component relative to the mask component 101 via a plurality of different detachable connections. For example, as illustrated in the exemplary mask component 101 shown in FIG. 2C, the outer surface 111a of an exemplary face seal component 111 may be defined by opposing lateral ends, such as, for example, a first lateral end 112a and a second lateral end 112b, and a bottom end 112c. As illustrated, in various embodiments, the plurality of integrated fastener components defined by the face seal component 111 and distributed about the outer surface 111a thereof may be arranged so as to define a plurality of strap component interfaces including a first strap component interface 121 provided at the first lateral end 112a of the outer surface 111a, a second strap component interface 122 provided at the second lateral end 112b of the outer surface 111a, and a third strap component interface 123 provided at the bottom end 112c of the outer surface 111a. In such an exemplary configuration, the strap component of an exemplary respiratory protective device 100 may be configured for detachable connection to the face seal component 111 at each of the plurality of strap component interfaces 121, 122, 123 such that, upon the strap component being secured relative to the mask component 101, the exemplary respiratory protective device 100 defines a corresponding plurality of integrated interface portions at the first lateral end 112a, the second lateral end 112b, and the bottom end 112c of the outer surface 111a of the face seal component 111. In various embodiments, the outer shell component 109 of the mask component 101 may be configured for attachment relative to the face seal component 111 and/or a strap component engaged with the face seal component 111 via a secondary fastening means, such as, for example, a snap button.

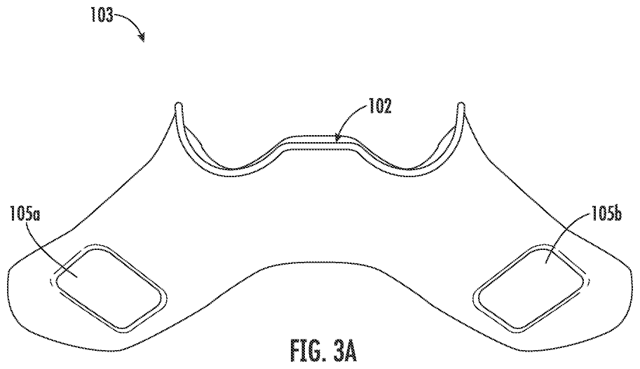

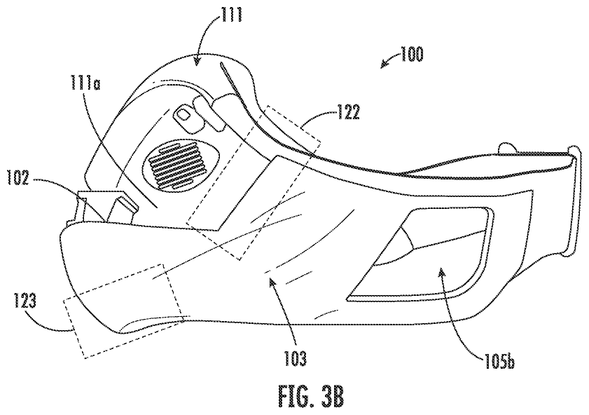

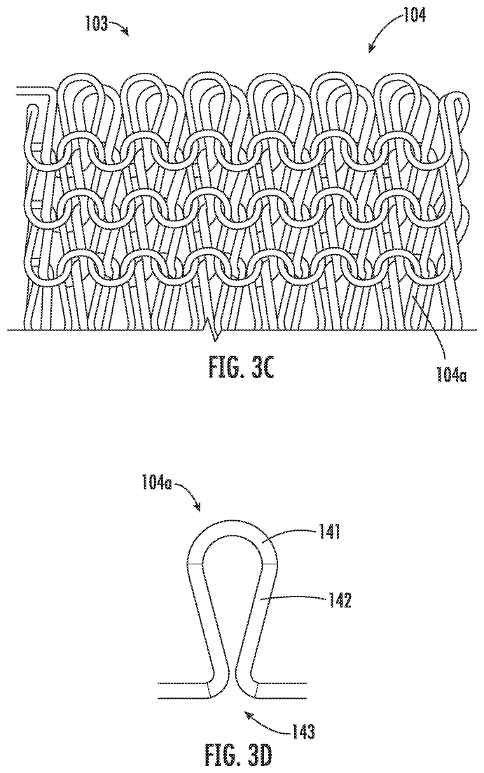

FIGS. 3A-3D illustrates various views of an exemplary respiratory protective device in accordance with various example embodiments described herein. In particular, FIG. 3A illustrates a perspective view of a strap component of an exemplary respiratory protective device and FIG. 3B illustrates a perspective view of an exemplary respiratory protective device having a detachable strap component in an attached configuration relative to a face seal component of a mask component 101 in accordance with various example embodiments described herein. As described herein, the strap component 103 of an exemplary respiratory protective device 100 may be configured to define a selectively detachable configuration relative to the mask component (e.g., the face seal component) of an exemplary respiratory protective device. In various embodiments, an exemplary strap component 103 may be defined by one or more material components configured to be worn on a head of the user such that, in an exemplary configuration wherein the strap component 103 is secured to a mask component (e.g., via one or more integrated interface portions), the strap component 103 may position the mask component (e.g., a face seal component) in a donned position against the face of the user. For example, an exemplary strap component 103 may define an inner surface and an outer surface. In various embodiments, the inner surface of the strap component 103 may be configured to face in a direction towards the head and/or face of a user upon being secured relative to the mask component of the exemplary respiratory protective device (e.g., when the exemplary respiratory protective device is being worn by the user). Further, the outer surface of the strap component 103 may define an opposite surface of the strap component 103 relative to the inner surface that is configured to face in one or more outward directions away from the head and/or face of the user when the strap component is selectively attached to the mask component (e.g., the face seal component) and the respiratory protective device is being worn by the user. In some embodiments, the strap component 103 may comprise an ear opening 105A and an ear opening 105B. In such an exemplary circumstance wherein the strap component 103 is attached relative to the mask component and the example respiratory protective device is being worn by a user, the first and second ear openings 105A, 105b may allow the left and right ears, respectively, of the user to pass therethrough in order to at least partially secure the position of the strap component relative to the user's ears.

In various embodiments, as described herein, a strap component 103 of an exemplary respiratory protective device may include one or more mask component interfaces defined by a plurality of looped fastener elements distributed along at least a portion of a strap component 103 surface and configured for engagement with the integrated fastener components of the mask component (e.g., at a corresponding one or more strap component interfaces defined by the mask component) to facilitate the detachable configuration of the strap component 103 relative to the mask component. As described herein, in various embodiments, at least a portion of a strap component, such as, for example, the exemplary strap component 103 illustrated in FIGS. 3A and 3B, may be made of a 3D knitted material defining an at least partially meshed configuration that enables the selective attachment of the at least a portion of the strap component 103 made of the 3D knitted material to the plurality of integrated fastener components defined by the mask component (e.g., the face seal component). In various embodiments, a portion and/or an entirety of an exemplary strap component 103 may be made of a fiber material that is knitted seamlessly using a 3D knitting process, as described herein. As non-limiting examples provided for illustrative purposes, in various embodiments, at least a portion of an exemplary strap component 103 may be made of a natural fiber material (e.g., a vegetable-base or cellulose-base fiber, such as, for example, cotton, flax, jute, and/or the like; an animal-base or protein-base fiber, such as, for example, wool, mohair, and/or silk), a chemical fiber material (e.g., viscose fiber, acetate fiber, polypropylene fiber, acrylic, nylon, terylene, and/or the like), a special fiber material (e.g., normal glass, activated carbon fibers, mineral fibers, elastane, conductive metallic wire, carbon fiber, arylon fiber, special glass fiber, ultra-high molecular weight polyethylene fiber, and/or the like), a functional fiber material (e.g., special-shaped fiber, hollow fiber, composite fiber, fine Denier fiber, antistatic fiber, high-shrinkage fiber, flame-retardant fiber, super-absorbent fiber, cool fiber, antibacterial fiber, antifouling fiber, intelligent fiber), and/or the like, or any combination thereof. In various embodiments, the exemplary strap component 103 may be at least partially made of an antimicrobial material. In some examples, the strap component 103 may therefore be manufactured as one single piece. As illustrated, in various embodiments, the strap component 103 may be shaped during the manufacturing process to fit on the face of a user.

For example, the 3D knitted material defining at least a portion of the strap component 103 may configured such that an attachment of the strap component 103 relative to a mask component is enabled by a portion of a surface of the strap component 103 (e.g., an inner surface) defined by the 3D knitted material being directly pressed against the plurality of integrated fastener components to force a physical interaction and/or engagement therebetween. As described in further detail herein, based at least in part on the design of the meshed configuration of the 3D knitted material, one or more loop fastener elements collectively defining the surface of the portion of the strap component 103 made form the 3D knitted material may be configured to be grabbed, secured, and/or otherwise engaged by the integrated fastener components of the mask component in order to attach the strap component 103 relative to the mask component surface (e.g., at a strap component interface).

As illustrated in FIG. 3C, an exemplary 3D knitted material portion defining at least a portion of (e.g., at least substantially all of) the strap component 103 may be manufactured using a 3D knitting processes defined by one or more loop knitting operations. For example, the 3D knitted material may be made to include a plurality of loop fastener elements 104 arranged in an overlapping and/or interlocking configuration relative to one another so as to define a meshed configuration having one or more threaded layers of interlocked loop fastener elements.

In various embodiments, the plurality of loop fastener elements 104 defining the 3D knitted material may be arranged in a clustered arrangement wherein at least a portion of the plurality of loop fastener elements 104 are disposed at substantially proximate one another so as to collectively define a mask component interface at which the strap component 103 is configured to engage the integrated fastener elements defined by the mask component to facilitate a detachable coupling relative to the mask component (e.g., the face seal component).

In various embodiments, a loop fastener element may be specifically configured to facilitate the detachable engagement of the integrated fastener components of the mask component relative thereto. For example, in an exemplary embodiment wherein the plurality of integrated fastener components defined by the mask component of the respiratory protective device embody hook fastener elements protruding in an outward direction from a surface of the mask component (e.g., an outer surface 111a of the face seal component 111, as shown in FIG. 2B), the plurality of loop fastener elements 104 defined by the 3D knitted material portion of the strap component 103 may be individually and collectively configured for receiving the integrated fastener components upon engagement of the loop fastener elements 104 with a strap component interface of the mask component. The plurality of loop fastener elements 104 defined by the 3D knitted material portion of the strap component 103 may be configured to engage and/or be engaged by the integrated fastener components of the mask component to establish a robust connection between the strap component 103 and the mask component that defies strong adhesion characteristics while maintaining a selectively detachable configuration between the two components. As a non-limiting example provided for illustrative purposes, in various embodiments, each loop fastener element 104a of the plurality of loop fastener elements 104 defined by the 3D knitted material of the strap component 103 may be defined by a relatively long, dangling looped configuration in order to maximize effective engagement of the integrated fastener components therewith.

FIG. 3D illustrates an exemplary loop fastener element 104a that may be made via a 3D knitting processes and is configured define at least a portion of a mask component interface of an exemplary strap component. An exemplary loop fastener element 104a may be configured for receiving at least a portion of an integrated fastener component within an interior looped portion thereof in order to secure the integrated fastener component in an attached configuration relative thereto and facilitate the coupling of the strap component to the mask component (e.g., the face seal component). For example, as illustrated, an exemplary loop fastener element 104a may comprise a top loop portion 141, one or more side loop portions 142, and a loop bottom portion 143 configured for arrangement relative to one or more other loop fastener elements via a half-interloop interlocking configuration.

In various embodiments, a loop fastener element defined by an exemplary 3D knitted material portion of the strap component 103 may be defined by one or more loop characteristics, such as, for example, a loop height, a loop length, an internal loop surface area, and/or the like. In various embodiments, the loop characteristics of each of the loop fastener elements 104a defined by the strap component of an exemplary respiratory protective device may be configured to promote the coupling of the loop fastener element 104a with an integrated fastener component engaged therewith and/or enable the selective detachment of the integrated fastener component therefrom to define the detachable configuration of the strap component relative to the mask component. For example, one or more of the loop characteristics (e.g., a loop height, a loop length, an internal loop surface area) of the loop fastener elements 104a of the plurality 104 may be based at least in part on one or more specific geometric and/or material properties of the integrated fastener components defined by the mask component (e.g., the face seal component). In various embodiments, an exemplary loop fastener element 104a may be configured for receiving at least a portion of an integrated fastener component within an interior looped portion thereof in order to secure the integrated fastener component in an attached configuration relative thereto and facilitate the coupling of the strap component to the mask component (e.g., the face seal component).

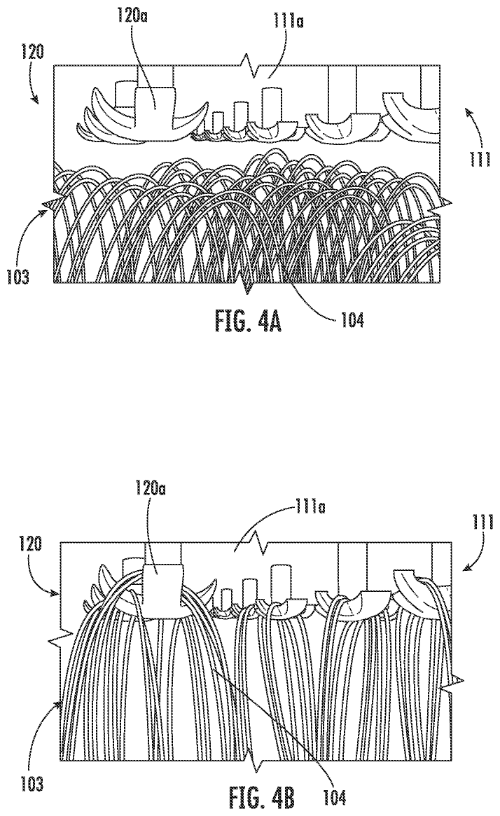

FIGS. 4A and 4B illustrate isolated views of various components of an exemplary respiratory protective device according to various embodiments described herein. In particular, FIG. 4A and FIG. 4B illustrate a plurality of integrated fastener components 120 defined along an outer surface 111a of a face seal component 111 provided in a disengaged condition and an engaged condition, respectively, relative to a plurality of loop fastener elements 104 of an exemplary strap component 103. As illustrated in FIG. 4A, the face seal component 111 of an exemplary mask component may define a plurality of integrated fastener elements 120 arranged in an array about an outer surface 111a of the face seal component so as to collectively define a strap component interface at which the mask component is configured to engage (e.g., secure) a strap component 103 at a corresponding mask component interface. As further illustrated, an exemplary strap component may include a mask component interface defined by a 3D knitted material portion of the strap component 103 having a plurality of loop fastener elements 104 at which the strap component 103 is configured to receive (e.g., secure) a face seal component 111 at the plurality of integrated fastener components 120 defining the strap component interface.

In various embodiments, each integrated fastener component 120a of the plurality of integrated fastener components 120 defined by the mask component (e.g., the face seal component 111) may be specifically configured for engagement with the plurality of loop fastener elements 104 defining the mashed configuration of the 3D knitted material portion of the strap component 103. For example, each integrated fastener component 120a protruding from the outer surface 111a of the face seal component 111 may be defined by a hook fastener component having a hook configuration specifically configured to promote the coupling of the integrated fastener component 120a with the plurality of loop fastener elements 104 engaged therewith and/or enable the selective detachment of the loop fastener elements 104 therefrom to define the detachable configuration of the mask component relative to the strap component 103. As non-limiting examples provided for illustrative purposes, in various embodiments, an exemplary integrated fastener component 120a may define a single hook configuration, a double hook configuration, a triple hook configuration, a mushroom-shaped configuration, and/or the any other hook configuration operable to facilitate the fastening functionality of a hook-and-loop fastener element with respect to the plurality of loop fastener elements defined by the strap component of an exemplary respiratory protective device, as described herein, or any combination thereof. For example, in various embodiments, an exemplary integrated fastener component 120a may be deliberately configured according to one or more functional considerations, such as, for example, having an at least partially flame-retardant characteristic, enabling an at least substantially silent attachment and/or detachment to and/or from an exemplary strap component, having an at least partially touch-safe characteristic defined by a reduced and/or minimized amount of exposed sharp edge portions, and/or the like, or any combination thereof.

For example, as illustrated in FIGS. 4A and 4B, an exemplary integrated fastener component 120a may embody a hook fastener component comprising an at least partially mushroom-shaped configuration defined by a base portion and a head portion. In various embodiments, the base portion of each integrated fastener component 120a may protrude from the outer surface 111a in an at least substantially outward direction to a distal base end that defines the position of the head component of the integrated fastener component 120a. As shown each integrated fastener component 120a may define a head portion having an at least partially dome-shaped configuration defined by a concave curvature facing towards the outer surface 111a. For example, an exemplary integrated fastener component 120a may define a dome-shaped head portion comprising a plurality of engagement arms (e.g., such as, for example, four engagement arms). In various embodiments, each of the plurality of curved engagement arms defined by an integrated fastener component 120a may be defined by a respective curvature in a direction at least partially towards the outer surface 111a of the face seal component 111 such that each engagement arm may be configured for establishing a connection with one or more of the plurality of loop fastener elements 104 that may operably prevent a loop fastener element engaged therewith from undesirably dislodging therefrom without a deliberate application of a separation force therebetween. Further, the dome-shaped configuration of the head portion of each integrated fastener component 120a may be configured to minimize the resistance acting on the plurality of loop fastener elements 104 as the 3D knitted material portion of the strap component 103 is moved towards the outer surface 111a. The rounded, at least partially dome-shaped configuration defined by the outward-facing surface of the integrated fastener component 120a (e.g., the head portion surface facing towards the plurality of loop fastener elements 104 as shown in the exemplary embodiments illustrated in FIG. 4A) may effectively redirect one or more loop fastener elements 104 around the head portion of the integrated fastener component 120a as the loop fastener elements 104 are moved toward the outer surface 111a during the selective engagement of the strap component 103 relative to the mask component.

Each integrated fastener component 120a defined by the face seal component 111 of the mask component may be configured to redirect a loop fastener element around the head portion upon an initial engagement therewith such that, as the mask component interface of the strap component 103 is further pressed (e.g., by a user) into the strap component interface defined by the plurality of integrated fastener components 120 (e.g., at least substantially towards the outer surface 111a at which the plurality of integrated fastener components 120 are disposed), the respective internal loop portions of the plurality of loop fastener elements 104 may be in position to receive one or more engagement arms of the plurality of integrated fastener components 120 therein.

As an illustrative example, FIG. 4B illustrates the plurality of loop fastener elements 104 defined by a 3D knitted material portion of the strap component 103 in an attached configuration relative to the plurality of integrated fastener components 120 defined by the mask component (e.g., the face seal component 111). In such an exemplary configuration, the engagement of the engagement arms defined by the head portion of each of the plurality of at least partially mushroom-shaped integrated fastener components 120 with one or more of the plurality of loop fastener elements 104 defined by the 3D knitted material portion of the strap component 103 may operably secure at least a portion of the strap component 103 relative to the face seal component 111 of the mask component. For example, as illustrated, the portion of the plurality of loop fastener elements 104 of the strap component 103 that is detachably secured relative to the plurality of integrated fastener components 120 and the integrated fastener components 120 attached thereto may collectively define an integrated interface portion of the respiratory protective device at which the strap component 103 is detachably secured relative to the mask component.

Referring back to the exemplary embodiment strap component illustrated in FIGS. 3A and 3B, the exemplary strap component 103 may define an strap upper edge portion 102 having a shape corresponding to that of at least a portion of the mask component (e.g., the face seal component) such that, in an exemplary configuration wherein the strap component 103 is attached to the mask component, the strap component 103 is at least substantially continuously engaged with the mask component along the length of the strap upper edge portion 102 (e.g., between a first lateral side and an opposing second lateral side of the strap component 103). For example, in various embodiments, the strap upper edge portion 102 (e.g., defined by an upper perimeter edge and the least substantially adjacent portions of the strap component 103) may be made of the exemplary 3D knitted material described herein. In such an exemplary embodiments, the strap upper edge portion 102 may define one or more mask component interfaces distributed along the length thereof in positions corresponding to the one or more strap component interfaces defined by the integrated fastener components of the mask component. For example, in an exemplary embodiment wherein the plurality of integrated fastener components of the mask component are distributed along an outer surface of the face seal component (e.g., at the first second and third strap component interfaces illustrated in FIG. 2C), the strap component 103 may be selectively attached relative to the plurality of integrated fastener components by causing an engagement of an inner surface of a 3D knitted material portion of the strap component 103 defined along the strap upper edge portion 102. In such an exemplary configuration, at least a portion of the strap component, including the 3D knitted material portions of the strap component 103 defining the one or more mask component interfaces, may be selectively secured relative to the outer surface of a face seal component of the mask component.

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A respiratory protective device comprising:
a mask component configured to engage a face of a user; and
a strap component configured for selective attachment to the mask component, the strap component being further configured to be worn by the user such that at least a portion of the mask component selectively attached thereto is positioned against the face of the user, wherein the strap component defines a selectively detachable configuration relative to the relative to mask component;
wherein the mask component comprises a plurality of integrated fastener components configured for selective engagement with at least a portion of the strap component to secure the strap component relative to the mask component, wherein the plurality of integrated fastener components are integrally configured as part of the mask component such that the mask component defines one or more strap component interfaces at which the mask component is configured for detachable attachment to the strap component.

2. The respiratory protective device of claim 1, wherein the plurality of integrated fastener components of the mask component comprise a plurality of hook fastener elements configured for engagement with a plurality of loop fastener elements defined by the one or more surfaces of the strap component.

3. The respiratory protective device of claim 2, wherein the plurality of integrated fastener components are provided at an outward-facing surface of the mask component.

4. The respiratory protective device of claim 3, wherein the plurality of integrated fastener components are distributed about the outward-facing surface so as to define one or more strap component interfaces positioned along one or more perimeter edge portions of the outward-facing surface at which the mask component is configured for selective attachment to the strap component.

5. The respiratory protective device of claim 4, wherein the one or more strap component interfaces comprises a plurality of strap component interfaces.

6. The respiratory protective device of claim 5, wherein the plurality of strap component interfaces comprises a first strap component interface defined by a first portion of the plurality of integrated fastener components arranged in a first array along a first lateral end of the mask component and a second strap component interface defined by a second portion of the plurality of integrated fastener components arranged in a second array along a second lateral end of the mask component.

7. The respiratory protective device of claim 6, wherein the plurality of strap component interfaces further comprises a third strap component interface defined by a third portion of the plurality of integrated fastener components arranged along a bottom end of the mask component.

8. The respiratory protective device of claim 1, wherein the mask component comprises a face seal component configured for configured for engagement with the face of the user and an outer shell component configured for attachment relative to the face seal component, wherein the plurality of integrated fastener components are defined by the face seal component.

9. The respiratory protective device of claim 8, wherein both the face seal component and the plurality of integrated fastener components defined by the face seal component are made via an injection mold process such that the face seal component and the plurality of integrated fastener components are defined by a singular material component.

10. The respiratory protective device of claim 8, wherein the plurality of integrated fastener components are distributed along one or more perimeter edge portions defined by an outer surface of the face seal component.

11. The respiratory protective device of claim 1, wherein at least a portion of the strap component is made from a 3-dimensional (3D) knitted material.

12. The respirator protective device of claim 11, wherein at least substantially an entirety of the strap component is made from the 3D knitted material.

13. The respiratory protective device of claim 1, wherein the strap component defines one or more mask component interfaces comprising a 3D knitted material portion defined by the strap component at which the strap component is configured for selective attachment to a corresponding one of the strap component interfaces defined by the mask component.

14. The respiratory protective device of claim 13, wherein the 3D knitted material portion defines at least a portion of a strap component surface such that the selective attachment of the mask component to the strap component is defined at least in part by an engagement of the plurality of integrated fastener elements with the strap component surface defined by the 3D knitted material portion.

15. The respiratory protective device of claim 13, wherein the 3D knitted material portion defines a plurality of loop fastener elements configured for selective attachment with the plurality of integrated fastener components of the mask component.

16. The respiratory protective device of claim 15, wherein each of the plurality of loop fastener elements comprises a top loop portion, one or more side loop portion, and a bottom loop portion that collectively define an inner loop portion, the plurality of loop fastener elements defined by the 3D knitted material portion being arranged in a half-looped interlocking configuration.

17. The respiratory protective device of claim 13, wherein the 3D knitted material portion defines at least substantially.

18. The respiratory protective device of claim 1, wherein each of the plurality of integrated fastening components comprise a base portion and a head portion, the base portion protruding from a surface of the mask component in an at least partially outward direction away from the surface to a distal base end, and the head portion being positioned at the distal base portion.

19. The respiratory protective device of claim 18, wherein the head portion of each of the integrated fastener components is defined by a respective plurality of curved engagement arms defined by a curvature directed towards the surface of the mask component from which the integrated fastener component protrudes.

20. The respiratory protective device of claim 19, the head portion of each of the integrated fastener components is defined by a respective outermost surface having an at least substantially rounded configuration.
